(19) United States
(12) Patent Application Publication
(10) Pub. No.: US 2007/0251849 A1
(43) Pub. Date: Nov. 1, 2007

(54) Devices for the identification of medical products

(76) Inventors: Denny Lo, Bethlehem, CT (US); Robert Huebner, Wallingford, CT (US); Jessica Perkins, Middletown, CT (US); Thomas Signore, Brookfield, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/634,531

(22) Filed: Dec. 6, 2006

Related U.S. Application Data
(60) Provisional application No. 60/796,121, filed on Apr. 27, 2006.

(51) Int. Cl. B65D 85/00; G09F 13/20

(52) U.S. Cl. 206/459.5; 40/542

(57) ABSTRACT

Devices in which components of medical kits are carried are identifiable by means other than by the naked eye. The means for identification is attached to or integral with the device and may comprise raised and lowered surfaces that can be read by touch; serrations disposed on an edge or surface; a fluorescent coating viewable under infrared or ultraviolet light; or a pattern that is viewable using a thermal imaging device such as night vision goggles. A package for retaining a medical item includes an identifying element of a material that is selectively viewable in response to light attributes of the material. A device for the visual identification of a package containing a medical item includes an identifying element comprising a material that is visually discernible in reduced-light environments via the use of night vision devices.

### CROSS-REFERENCE TO RELATED APPLICATION

This application claims the benefit of U.S. Provisional Patent Application No. 60/796,121, filed on Apr. 27, 2006, the contents of which are incorporated herein by reference in their entirety.

### TECHNICAL FIELD

The present invention relates generally to medical products and, more particularly, to devices that facilitate the identification of medical products under low-light or no-light conditions.

### BACKGROUND OF THE PRESENT INVENTION

Medical products in kit form are typically carried by military personnel, law enforcement personnel, and rescue personnel or other first responders into emergency situations. The various products chosen for inclusion in the kit are generally those used to at least temporarily address a wound and to stabilize a patient until the patient can be transported to a medical facility. These products generally include bandages, gauze, and compounds such as iodine solutions or other ointments that may be applied to wounds to improve septic conditions. Other products may include smelling salts, salt tablets, and devices for the automatic injection of compounds to treat anaphylactic shock (such as an EPIPEN).

First aid, particularly in military scenarios, must often be administered in less than favorable conditions such as in low light or in the dark. It is often impractical to provide artificial lighting in such scenarios because lighting may be unavailable or may attract hostile attention to both the wounded person and the caregiver. Especially under battle conditions, even the use of pen-type flashlights or similar devices may be susceptible to undesirable detection.

Situations may also occur in which a person's vision is impaired so that he/she may not be able to open the medical kit. A person may also be blinded as a result of foreign objects such as dust, smoke, chemical vapors, blood, or the like in addition to direct injury to the eyes. In these types of situations, no amount of light would enable the blinded person to see sufficiently to self-administer the needed aid. Furthermore, unless a caregiver is adequately equipped with the necessary paraphernalia (respirators or masks) to counter the effects of dust, smoke, chemical vapors, etc., the caregiver is also unlikely to be able to access the medical kit and the contents therein.

There is a current need for an improved manner of identifying emergency medical products under less than adequate lighting conditions or in situations in which vision is impaired.

Based on the foregoing, it is a general object of the present invention to provide devices that facilitate the identification of medical products under low-light or no-light conditions to allow for the application of such products to wounded personnel.

### SUMMARY OF THE PRESENT INVENTION

Disclosed herein are devices that facilitate the identification of medical products under low-light or no-light conditions. Such conditions may be encountered in battle situations, in covert operations for purposes relating to reconnaissance or personnel and/or equipment transport, or as a result of climatic or environmental situations. The present invention is not limited in this regard, however, as other uses for the disclosed devices are within the scope of the invention. For example, the devices disclosed herein may also be utilized in conjunction with ammunition holders, communications apparatuses, tools, and the like.

In one aspect, the present invention resides in a pouch in which components of a medical kit are carried, the pouch being identifiable by means other than by the naked eye. The pouch is preferably closable using snaps, hook and loop material, zippers, or the like. The means for identification is attached to or integral with the pouch and may comprise raised and lowered surfaces that can be read by touch; serrations disposed on an edge or surface; a fluorescent coating viewable under infrared or ultraviolet light; or a pattern that is viewable using a thermal imaging device such as night vision goggles.

In another aspect, the present invention resides in a device for the identification of a medical item. The device is attachable to the medical item or to the packaging incorporating the item and includes a substrate and an arrangement of raised and lowered surfaces disposed thereon. The raised and lowered surfaces, which may be ridges, grooves, pimples, dimples, holes, Braille, or combinations thereof, define a pattern that is tactilely recognizable by a user when the user touches the raised and lowered surfaces.

In another aspect, the present invention resides in a device for the selective visual identification of a medical item. The device is attachable to the medical item and includes a substrate and a fluorescent ink disposed thereon. The fluorescent ink is visible under one of infrared light and ultraviolet light and is disposed on the substrate in a recognizable pattern (e.g., a medical cross).

In another aspect, the present invention resides in a device for the identification of a medical item, the device being attachable to the medical item. The device includes a substrate and a coating disposed thereon. The substrate is defined by a material having a first specific heat capacity, and the coating is defined by a material having a second specific heat capacity. The coating is disposed on the substrate in a recognizable pattern. The two specific heat capacities are different, which thereby allows one to be recognized relative to the other when viewed through a thermal imaging apparatus such as night vision goggles.

In another aspect, the present invention resides in a package for retaining a medical item. The package includes an identifying element of a material that is selectively viewable in response to light attributes of the material. The material is arranged to identify the contents of the package via lettering, colorings, graphics, combinations of the foregoing, and the like.

In another aspect, the present invention resides in a medical device that includes a hemostatic agent; a package in which the hemostatic agent is retained; and an identifying element on the package. The identifying element includes a material that is visually discernible in reduced light environments.

In another aspect, the present invention resides in a device for the visual identification of a package containing a medical item. Such a device includes an identifying element comprising a material that is visually discernible in reduced-light environments via the use of night vision devices. The identifying element may be formed into an indicia that indicates the contents of the package.

One advantage of the present invention is that a medical device can be utilized under hostile conditions without drawing unwanted attention. More specifically, by relying on tactile senses or the use of optical devices (such as those emitting infrared or ultraviolet light or those capable of reading thermal infrared radiation), a medical device can be found, opened, and applied as necessary for the treatment of a wound without compromising the position of the user.

Another advantage is that a medical device can be utilized under conditions in which the user is blinded. Rescue personnel, as well as law enforcement and military personnel, can rely on tactile abilities to locate specific items or to distinguish types of items for application in emergency situations such as heavy smoke, dust storms, and the like.

### BRIEF DESCRIPTION OF THE DRAWINGS

FIG. 1 is a perspective view of the front of a medical kit having an identification device of the present invention.

FIG. 2 is a perspective view of the back of the medical kit of FIG. I showing the identification device of the present invention.

FIG. 3 is a perspective view of the identification device of the present invention in which the device is identifiable by tactile means.

FIG. 4 is a perspective view of the identification device of the present invention in which the device is identifiable by a selectively viewable means.

FIG. 5 is a perspective view of the identification device of the present invention in which the device is identifiable by a thermally-imagable means.

FIG. 6 is a perspective view of a package of blood clotting agent having the identification device of the present invention.

FIG. 7 is a perspective view of a package of blood clotting agent having a serrated edge as the identification device of the present invention.

### DETAILED DESCRIPTION OF THE PREFERRED EMBODIMENTS

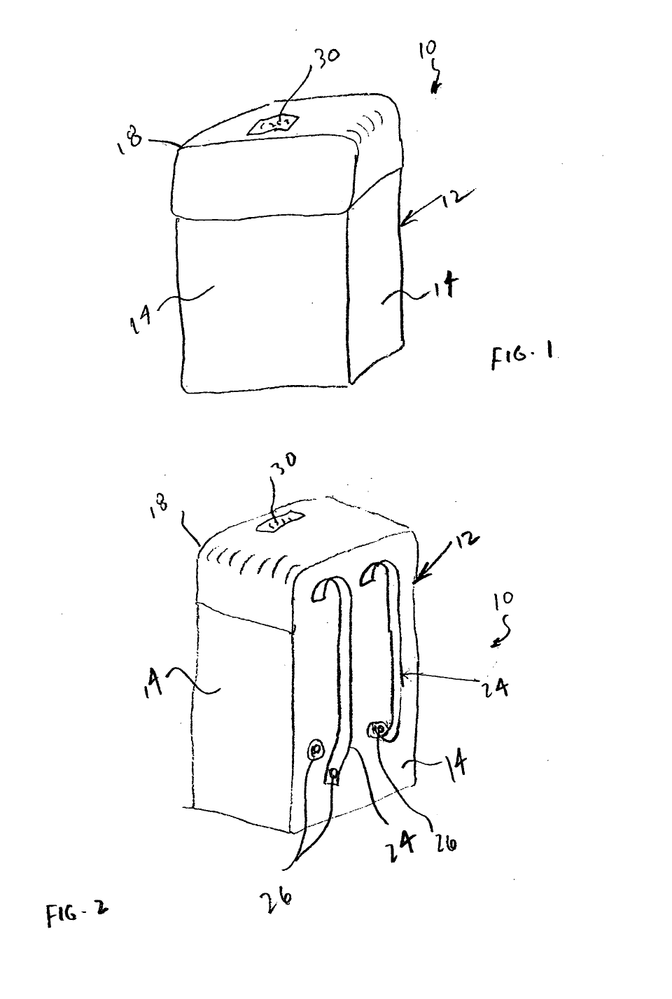

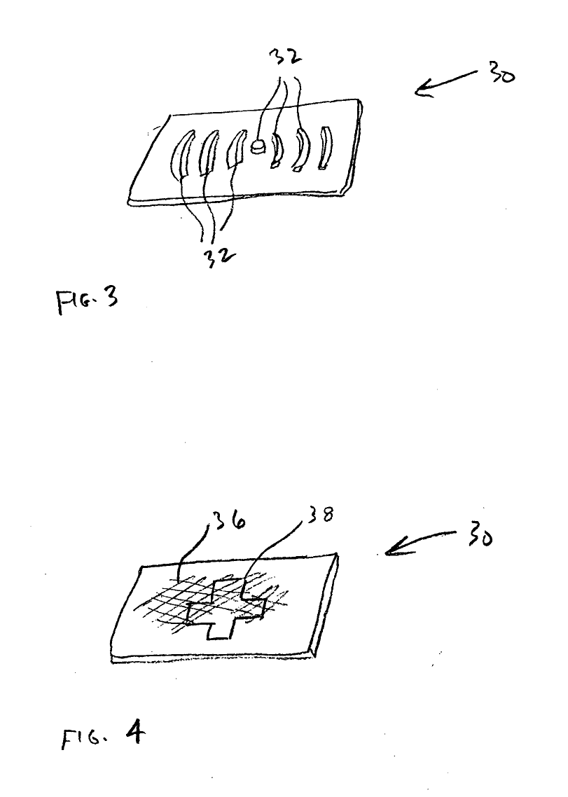

As shown in FIGS. 1 and 2, a medical kit generally designated by the number 10 includes a bag or pouch 12 that functions as a receptacle for various components that make up the kit. Components that make up the kit 10 can include, but are not limited to, bandages, antiseptic compounds, tape, and packages or vials of blood clotting agents.

Referring specifically to FIG. 2, an attachment mechanism is also disposed on at least one wall 14 of the pouch 12 to facilitate the attachment of the pouch to a belt, vest, or other garment of the user. The attachment mechanism includes one or more straps 24 that are stitched or otherwise secured to the at least one wall 14 at one end thereof. The straps 24 can be looped around a belt or loops on a garment and attached back to the pouch 12 using snaps 26 (as shown) or any other suitable mechanism (e.g., hook and loop material, quick-release buckles, or the like). The straps 24 may also be utilized in conjunction with a MOLLE connection at the discretion of the user.

Referring to both FIGS. 1 and 2, the pouch 12 includes at least one identifying element 30 having a surface that can be discerned without the naked eye (e.g., by being identified through touch or by being selectively viewable through a device in response to colorings or certain light attributes (phosphorescence or luminescence)). The present invention is not limited in this regard, however, as the pouch 12 may alternatively (or additionally) include at least one identifying element 30 having a surface that can be discerned with the naked eye (e.g., by being identified in response to the certain light attributes (the phosphorescence or luminescence)). The identifying element 30 may form the surface or it may be attached to specific individual components of the kit 10, e.g., the packaging of individual components. Irrespective of where the identifying element 30 is located, the identifying element can be inspected by a user under low-light or no-light conditions to allow the user to determine the type of kit, the contents of the pouch 12, or the particular kit component. In embodiments in which the identifying element 30 is attached to the pouch 12, the identifying element can be located anywhere on the pouch, although the identifying element is preferably located on a top 18 of the pouch to indicate the point at which the pouch can be opened.

Referring now to FIG. 3, in one exemplary embodiment the identifying element 30 may be a device that provides a tactile sensation. The identifying element 30 may be in the form of a patch, tag, or label or the like embossed or otherwise made to have one or more raised surfaces 32 that, when touched by a user, allow the user to discern a pattern or recognizable indicia. Raised surfaces 32 of the identifying element 30 may be ridges, grooves, buttons, pimples, dimples, holes, conventional Braille nomenclature, combinations of the foregoing, or the like. Material from which the identifying element 30 is manufactured is a material that is not capable of easily being detected using conventional surveillance techniques. The material has a matte (or at least low gloss) finish in order to minimize detection by optical means. Materials include, but are not limited to, nylon, plastic, rubber, cloth, and the like.

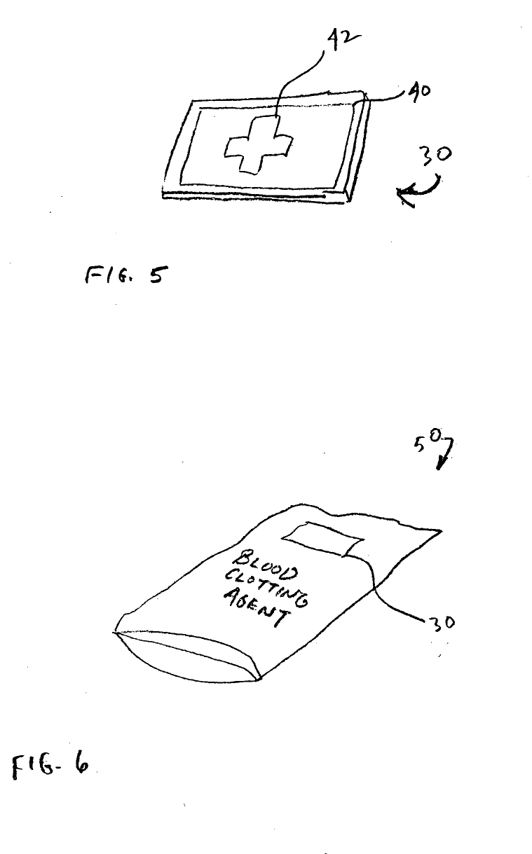

Referring now to FIG. 4, in another exemplary embodiment the identifying element 30 is a surface that is selectively viewable. The surface may be disposed on a label, tag, patch, or the like for attachment to a bag or pouch. The present invention is not limited in this regard, however, as the surface of the identifying element 30 may be printed, painted, stamped, or inked directly onto a bag or pouch.

In addition to being visible with the naked eye under ambient light conditions, the identifying element 30 includes attributes that allow it to be visually discerned with the naked eye in low-light or no-light environments. Such attributes may be embodied in materials that include, but are not limited to, photoluminescent materials (e.g., an ink 36 or other material). The photoluminescent materials for use with the present invention include, but are not limited to, phosphorescent materials; fluorescent materials; paints, inks, or dyes that emit light when subjected to blacklight; chemical sources such as phenyl oxylate esters; combinations of the foregoing; and the like. Phosphorescent material is particularly useful for devices that are not intended to be used in situations that require stealth (e.g., civilian paramedic and rescue situations).

Also the ink 36 or other material may include a material that is visible under infrared or ultraviolet light or a material that allows the identifying element to be viewed in partial or complete darkness using night observation devices or night vision devices, e.g., night vision goggles and/or night vision monoculars. Passive night vision devices (those which pick up any light in the immediate area and amplify it thereby allowing it to be seen) are preferred over active night vision devices (those which project infrared light and produce an image from the light reflected back). The material may be photoluminescent or it may comprise paints, inks, or dyes of a particular color that facilitates the viewing of the material through night observation devices or night vision devices.

Identifying indicia such as text or other markings may be part of the identifying element 30. For example, a cross 38 or similar recognizable pattern may be superimposed on the ink 36 or material (or the ink or material may be superimposed on the cross) to allow a person to view the identifying element 30 under normal lighting or in low-light or complete darkness.

Referring to FIG. 5, in any embodiment, a portion of the identifying element 30 may be fabricated from a material having a specific heat capacity, thus allowing it to be imaged thermally. If the identifying element 30 is defined at least in part by a substrate 40 that includes a patterned coating 42 of a disparate material, differences in heat retention properties of the two materials can be simultaneously read and processed to produce an image. For example, if a coating of graphite (specific heat capacity of 0.720 Joules/gram/degree Kelvin) is deposited on brass (specific heat capacity of 0.377 Joules/gram/degree Kelvin), a thermal imaging apparatus can be utilized to view the pattern of the graphite coating (e.g., in the shape of a cross). The thermal imaging apparatus may be one capable of reading thermal infrared radiation, such as a night vision device.

Referring back to FIG. 4, the ink 36 (or other material) may include a material having a first specific heat capacity, and it may be deposited onto a substrate having a second specific heat capacity in such a way so as to define the recognizable pattern. Thus, the identifying element 30 may be read using any one of visible light, infrared or ultraviolet light, or thermal imaging, or it may be viewable as a result of the absorption and re-emission of light.

One of the components that make up the kit 10 may be a blood clotting agent in particle, granule, or powder form for application to a bleeding wound. Such a blood clotting agent is generally zeolite-based, although other types of blood clotting agents are within the scope of the present invention.

Referring now to FIG. 6, one embodiment of a package in which the blood clotting agent is sealed is shown at 50 and is hereinafter referred to as “package 50.” Package 50 includes the identifying element 30 as described above. The identifying element 30 may be a patch or the like configured to impart a tactile sensation, a label having a reflective ink or photoluminescent material as described herein, a marking defined by a reflective ink or photoluminescent material as described herein disposed on a surface of the package, a patterned coating capable of being thermally imaged, or a combination of the foregoing. The identifying element 30 may alternately or additionally be any indicia that is visible under ambient light conditions and visible under low-light or no-light conditions using active or passive night vision goggles or devices. The package 50 is typically a foil that in which the blood clotting agent is vacuum sealed.

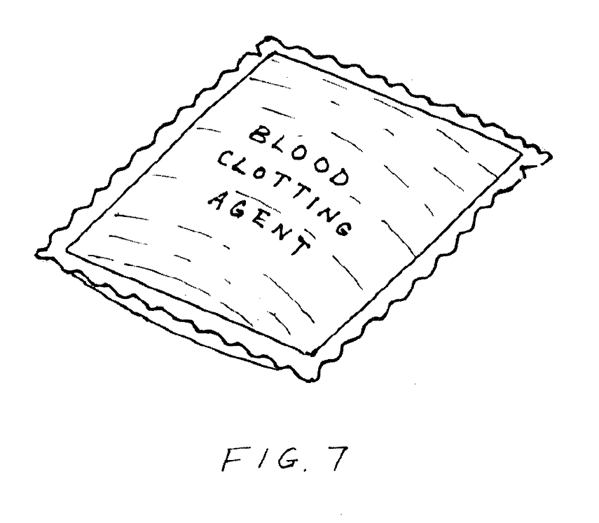

Referring now to FIG. 7, another embodiment of a package in which the blood clotting agent is sealed is shown at 150 and is hereinafter referred to as “package 150.” Package 150 includes a serrated edge 31 as the identifying element. The serrated edge 31 is cut or otherwise formed at the edge of the material forming the package 150. Particularly when the package 150 is fabricated by joining two foil sheets along their respective edges, serrations may be cut into the joined edges. A user may, by touching the serrated edge 31, be able to identify the contents of the package 150. The present invention is not limited in this regard, however, as items other than blood clotting agents may be disposed in the package 150 having the serrated edge 31.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A medical device, comprising:
a pouch defined by at least one wall, said pouch being configured to retain medical products therein; and
means for identification attached to said pouch, said means for identification comprising a surface that is discernable by a device other than a naked eye.

2. The medical device of claim 1, further comprising a top attached to said pouch, said means for identification being attached to said top.

3. The medical device of claim 1, further comprising an attachment mechanism disposed on said at least one wall of said pouch, said attachment mechanism being configured to facilitate the attachment of said pouch to a garment.

4. The medical device of claim 3, wherein said attachment mechanism is a strap that is selectively attachable back to said pouch.

5. The medical device of claim 1, wherein said means for identification is a device having a pattern of raised and lowered surfaces.

6. The medical device of claim 5, wherein said pattern of raised and lowered surfaces consists of ridges, grooves, buttons, dimples, pimples, holes, Braille nomenclature, or combinations of the foregoing.

7. The medical device of claim 1, wherein said means for identification is a device having a selectively viewable surface.

8. The medical device of claim 7, wherein said device having said selectively viewable surface is a coating of fluorescent ink.

9. The medical device of claim 7, wherein said device having said selectively viewable surface comprises,
a substrate fabricated from a material having a first heat capacity, and
a patterned coating disposed on said substrate, said patterned coating being fabricated from a material having a second heat capacity.

10. The medical device of claim 7, wherein said device having said selectively viewable surface is discernable using a thermal imaging technique.

11. A device for the tactile identification of a medical item, said device being attachable to said medical item, said device comprising:
a substrate; and
an arrangement of raised and lowered surfaces disposed on said substrate;
wherein said raised and lowered surfaces define a pattern that is recognizable by touching said raised and lowered surfaces.

12. The device of claim 11, wherein said arrangement of raised and lowered surfaces is embossed into said substrate.

13. The device of claim 11, wherein said substrate comprises a material having a first specific heat capacity and wherein said raised surfaces comprise a material having a second specific heat capacity.

14. The device of claim 13, wherein said material having said first specific heat capacity and said material having said second specific heat capacity are capable of being thermally imaged.

15. The device of claim 11, wherein said substrate is fabricated from a material selected from the group consisting of nylon, plastic, rubber, cloth, and combinations of the foregoing..

16. A device for the selectively visual identification of a medical item, said device being attachable to said medical item, said device comprising:
a substrate; and
a fluorescent ink disposed on said substrate, said fluorescent ink being visible under one of infrared light and ultraviolet light.

17. The device of claim 16, wherein said fluorescent ink is disposed on said substrate in a recognizable pattern.

18. The device of claim 16, wherein said substrate is defined by a material having a first specific heat capacity and wherein said fluorescent ink includes a material having a second specific heat capacity, said substrate and said material included in said fluorescent ink thereby emitting disparate amounts of thermal infrared radiation readable using a thermal imaging technique.

19. A device for the identification of a medical item, said device being attachable to said medical item, said device comprising:
a substrate defined by a material having a first specific heat capacity; and
a coating disposed on said substrate, said coating being defined by a material having a second specific heat capacity;
wherein said coating is disposed on said substrate in a recognizable pattern.

20. The device of claim 19, further comprising an arrangement of raised and lowered surfaces disposed on said substrate in a recognizable pattern for the tactile identification of said device.

21. The device of claim 19, further comprising a fluorescent ink disposed on said substrate in a recognizable pattern for the identification of said device using one of an infrared light source and an ultraviolet light source.

22. A container for a medical item, said container being capable of tactile identification, said container comprising: an edge being defined by a plurality of surfaces, said surfaces defining a pattern that is recognizable by touching said surfaces.

23. The container of claim 22, wherein said pattern is a plurality of serrations.

24. The container of claim 22, wherein said container is fabricated from foil.

25. The container of claim 24, wherein said pattern is a plurality of serrations cut into an edge of said foil.

26. A package for retaining a medical item, said package comprising:
an identifying element disposed on said package;
wherein said identifying element comprises a material that is selectively viewable in response to light attributes of said material, said material being arranged to identify the contents of said package.

27. The package of claim 26, wherein said identifying element is attached to said package and is selected from the group consisting of labels, tags, and patches.

28. The package of claim 26, wherein said identifying element is disposed on said package by being printed, painted, stamped, or inked onto a surface of said package.

29. The package of claim 26, wherein said material of said identifying element is a phosphorescent material.

30. The package of claim 26, wherein said material of said identifying element is selected from the group consisting of fluorescent materials; paints, inks, and dyes that emit light when subjected to blacklight; phenyl oxylate esters; and combinations of the foregoing.

31. The package of claim 26, wherein said identifying element is visible under one or more of infrared light and ultraviolet light.

32. The package of claim 26, wherein said identifying element is visible using a night vision device.

33. A medical device, said device comprising:
a hemostatic agent;
a package in which said hemostatic agent is retained; and
an identifying element on said package, said identifying element comprising a material that is visually discernible in reduced light environments.

34. The medical device of claim 33, wherein said identifying element comprises a phosphorescent material.

35. The medical device of claim 33, wherein said identifying element includes a material selected from the group consisting of fluorescent materials; paints, inks, and dyes that emit light when subjected to blacklight; phenyl oxylate esters; and combinations of the foregoing.

36. The medical device of claim 33, wherein said identifying element is viewable using a night vision device using at least one of a passive means and an active means.

37. A device for the visual identification of a package containing a medical item, said device comprising:
an identifying element comprising a material that is visually discernible in reduced-light environments via the use of night vision devices, said identifying element being formed into an indicia that indicates the contents of the package.

38. The device of claim 37, wherein said material comprises a phosphorescent material.

39. The device of claim 37, wherein said material is selected from the group consisting of fluorescent materials; paints, inks, and dyes that emit light when subjected to blacklight; phenyl oxylate esters; and combinations of the foregoing.

40. The device of claim 37, further comprising a package onto which said identifying element is attached.

41. The device of claim 37, wherein said material is in the form of an ink, a paint, or a dye.

42. The device of claim 41, wherein said ink, said paint, or said dye emits light when subjected to blacklight.
